(19) United States
(12) Patent Application Publication
(10) Pub. No.: US 2005/0047710 A1
(43) Pub. Date: Mar. 3, 2005

(54) MEMS and liquid crystal based optical switch

(76) Inventors: Dhiraj Sinha, Muzaffarpur (IN); Vishal Kumar, Bareilly (IN); Durg Singh Chauhan, Varanasi (IN)

Correspondence Address: DHIRAJ SINHA;C/O R.N.P. SINHA, YADAV NAGAR, KRISHNA VIHAR, BHAGWANPUR CHATTI, MUZAFFARPUR, 842001, IN

(21) Appl. No.: 10/649,129

(22) Filed: Aug. 26, 2003

(51) Int. Cl. G02B 6/26

(52) U.S. Cl. 385/18

(57) ABSTRACT

In “All Optical Networks”, switching is done using micro-mirrors and liquid crystals. In one embodiment of the invention, the micro-mirrors are controlled using an electromagnetic control. In a slight variant of this invention the mirrors slide along certain points in a two dimensional matrix and do the switching. In yet another embodiment, the mirrors are mounted on a liquid crystal. Applying an external electric field deforms the liquid crystal. By changing the shape of the liquid crystal, change in directional orientation is brought and switching of the optical signal is done. In the final embodiment, switching is done by successive refraction and reflection of light through an electro-optic material as the refractive index is varied under an external electric field.

### REFERENCES CITED

U.S. Patent Documents

| | | |
|---|---|---|
| 5,808,384 | Sep. 15, 1998 | Tabat, et al. |
| 6,556,737 | Apr. 29, 2003 | Miu, et al. |

### FIELD OF USE

The present invention is on fibre-optic switches based on “MEMS based micro-mirrors” and liquid crystals.

### BACKGROUND ART

Switching of optical signals is one of the fundamental problems of optical communication systems. Electronic switching needs conversion of optical signals to electrical current, switching and then re-conversion of the electrical current to light. This results in the addition of noise and is quite inefficient. Today we talk of “all optical systems” in which switching does not require electronic apparatus and we use optical switches which direct optical beams in a desired directions. They have a number of input and output ports e.g. an NXN switch has N input and N output ports. Efficient switching of the optical signals between the fibres is necessary in order to achieve the desired routing of the signals. Desirable performance characteristics of the fibre optic switch include low loss and fast switching speed. Some innovative technologies involve MEMS based micro-mirrors and liquid crystals for switching purposes.

MEMS based technology is inexpensive and efficient. Micro-mirrors on silicon are produced using micromachining. They are pivoted on a hinge about an axis. The arrangement of the mirrors is on an array on a substrate and have electrodes placed close to them. Applying external electric fields to the electrodes changes their spatial orientation. In this way the path of the input signal is changed.

Two fundamental types of MEMS optical Switches are in use: two-dimensional (2-D or N×N architecture) and three-dimensional (3-D or analog 2N architecture). In 2-D architectures, a two dimensional array of micromirrors and fibers are arranged in a single plane. In this approach, an array of MEMS micromirrors is used to connect N input fibers to N outputs. This is called an N×N architecture, as it uses N×N individual mirrors to address N channels. To establish a light path connection between an input and output fiber, one mirror is activated while the other mirrors are deactivated. 3-D analog or beam-steering architectures use a 2N approach for photonic interconnects in three-dimensional space. Two arrays of N mirrors each are used to connect N input to N output fibers, each mirror having two degrees of freedom and multiple possible positions (at least N positions). The advantage of this architecture is that it is scalable to very high port counts (e.g., 1000×1000). The number of mirrors required to route all of the signals simultaneously are 2 times the number of wavelengths (i.e., 2N).

In switching techniques using liquid crystals, unpolarized light is allowed to pass through a liquid crystal slab, which polarizes the signal into various components, and then switching is done depending on the polarization of the signal. The essential components are passive optics—birefringent crystals that split and recombine the optical signal into two orthogonally polarized beams and a liquid crystal cell as the active element. The liquid crystal cell functions as a polarization rotator; controlling the voltage across the liquid cell allows redirection of the optical signal to an alternate outgoing fibre. This device is used in basic protection switching applications. By varying the amount of polarization shift through the liquid crystal cell, this basic architecture can be adapted to create a variable optical attenuator or variable optical couplers.

The techniques outlined above have some key problems, which the present invention aims to resolve. Electrostatic control of micro-mirrors has problems like high electrical stresses at the micro-projections of the semiconductor. This leads to slow discharge and possibilities of electrical breakdown remain. The electrodes have to be continuously charged and proper insulation has to be maintained considering the electrostatic interactions. The mirrors keep vibrating and there is no way to damp the vibrations. Switching of the mirrors needs time and this causes delay in the transfer of the signal. Electromagnetic control of micro-mirrors are quite new and such a method has been discussed in the U.S. patent application entitled “Silicon bulk-micromachined electromagnetic fiber-optics bypass microswitch” (U.S. Pat. No. 6,556,737).

Liquid crystal based switches are polarization dependent and not useful for large scale switching. The physical properties of the liquid crystals are highly affected by temperature so the switching is not quite efficient. Besides all these, they are highly expensive.

### SUMMARY

Magnetic circuits are widely used in electrical machinery. Usually a coil is wound around a ferromagnetic substance that forms a closed loop with an air gap. When a direct current is set up in the coil, magnetic flux lines are set up and magnetic energy remains concentrated in the air gap of the circuit. The system has a tendency to reduce the reluctance of the air gap and so when any magnetic material is left close to the circuit, it is attracted towards the air gap. This concept has been used in controlling the orientation of micro-mirrors created through bulk micro machining on silicon.

In the first embodiment of the device, a micro-mirror is placed in the centre of two magnetic circuits. The mirror has two plungers located at its ends. The plungers are made of a soft magnetic material. When current flows in one of the magnetic circuits, magnetic flux lines are set up and the plunger is attracted by the air gap and the mirror tilts its position and reaches a stable position. When its position has to be changed, the current in the coil is switched off and the current in the other coil is switched on. The two coils can have the same source of emf, which shall be connected to a diode, and depending on the polarity of the emf source, current in the coil can be maintained and switching of the mirrors achieved. In a slight variant of this device, there is only one magnetic circuit and the mirror is in a mechanical stability at one of its positions. To bring about a change in its position, the current in the coil is switched on. The efficiency of this device can be augmented by having a permanent magnetic material in the core of the magnetic circuit.

In another embodiment of the device, the mirrors can slide on a surface. The base of the mirrors is flat but the edges are curved. Plungers made of magnetic materials are connected at the ends and the mirrors show change in position in space when the magnetic circuits are switched on.

In the third embodiment, switching is done by connecting micro-mirrors to slabs of liquid crystals and then changing the shape of the liquid crystal by the application of an external electric field. This technique combines the advantages of switching using liquid crystal and switching using micro-mirrors. The switching efficiency can be increased by making use of levers connected to the mirror and the slab of the liquid crystal.

The method outlined above can also be used to control the position of micro-lenses, prisms, fibre-optics and collimators.

In the fourth embodiment of the device, the micro-mirrors are quite immovable. We use a thin slab of a transparent material whose refractive index could be changed. Before reflection, rays of light undergo refraction from one of the faces. The lower end of the glass slab is polished. The same ray of light follows different paths for different refractive indices, but the light that comes out after final refraction and reflection is parallel to all the possible paths. In this way the spatial variation of the ray of light is done. The geometrical shape of the slab can be varied to modulate the path of the signal.

### BRIEF DESCRIPTION OF THE DRAWINGS

FIG. 1 shows a two dimensional array of micro-mirrors fabricated using MEMS technology.

FIG. 2-a, 2-b, 2-c, 2-d and 2-e show bundles of optical fibres and switching of signals between them using mirrors and lenses.

FIG. 3 shows a magnetic circuit having a plunger and an air gap.

FIG. 4-a shows a micro-mirror having two magnetic plungers connected at the ends and resting on a hinge.

FIG. 4-b indicates two magnetic circuits with the mirror at the centre.

FIG. 4-c is a two dimensional array of micro-mirrors and magnetic circuits.

FIG. 4-d shows the three-dimensional view of the orientation of the micro-mirror, the magnetic circuit and the plunger.

FIG. 4-e shows a micro-mirror surrounded by four magnetic circuits so that the micro-mirror could be oriented in a three dimensional space.

FIG. 5-a has a magnetic circuit and a micro-mirror in one of its stable positions.

FIG. 5-b shows a magnetic circuit with a magnetic material in the core.

FIG. 5-c shows two-dimensional array of FIG. 5-a.

FIG. 6-a presents a view of the mirror with a flat base and curved ends.

FIG. 6-b presents its top view.

FIG. 6-c demonstrates a two dimensional representation of the sliding mechanism of the mirrors in a two dimensional space.

FIG. 7-a is a slab of liquid crystal with a micro-mirror attached to its end.

FIG. 7-b shows the deformation of the slab and tilting of the mirror under the application of an external field.

FIG. 7-c shows the slab of FIG. 11-b deformed in the opposite direction under an external field.

FIG. 8-a shows a lever connected at one end of the liquid crystal.

FIG. 8-b shows change in spatial orientation of the mirror using the lever arm.

FIG. 9-a shows a slab of a transparent electro-optic material polished at the other end. The rays of light passing through it for two different values of refractive indices are shown.

FIG. 9-a1 shows the FIG. 9-a with a portion of the upper surface polished.

FIG. 9-b shows the rays of light passing through the side of the slab of FIG. 9-a after refraction and reflection.

FIG. 9-c shows the FIG. 9-a with a side cleaved (faceted).

FIG. 9-d shows the same phenomenon with the cleaved side polished.

FIG. 9-e shows the same phenomenon with two sides polished.

### DETAILED DESCRIPTION

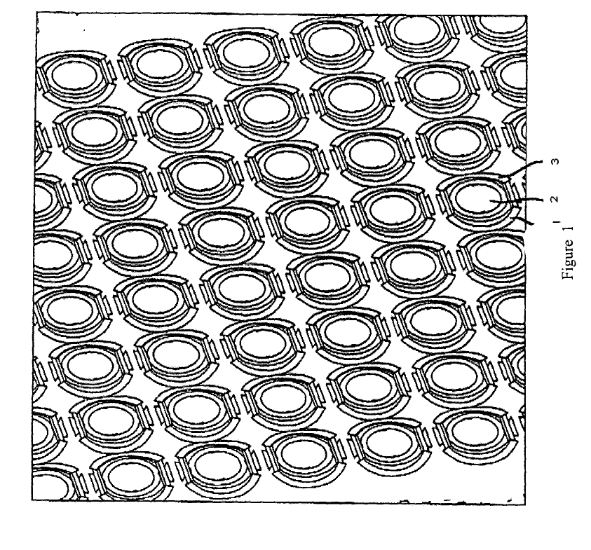

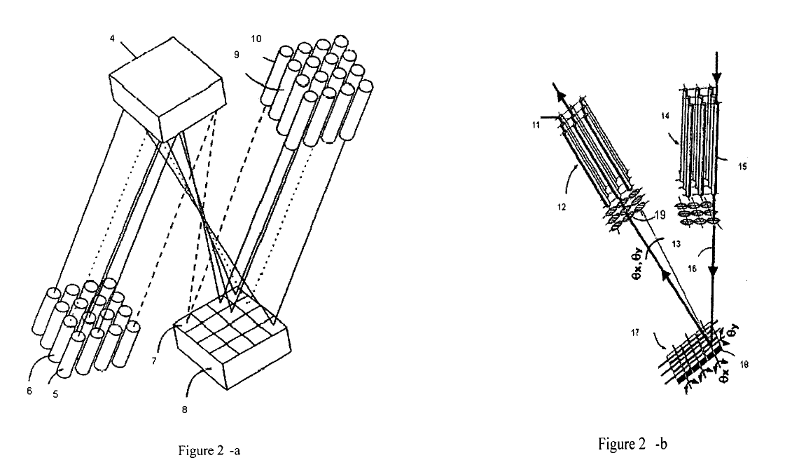

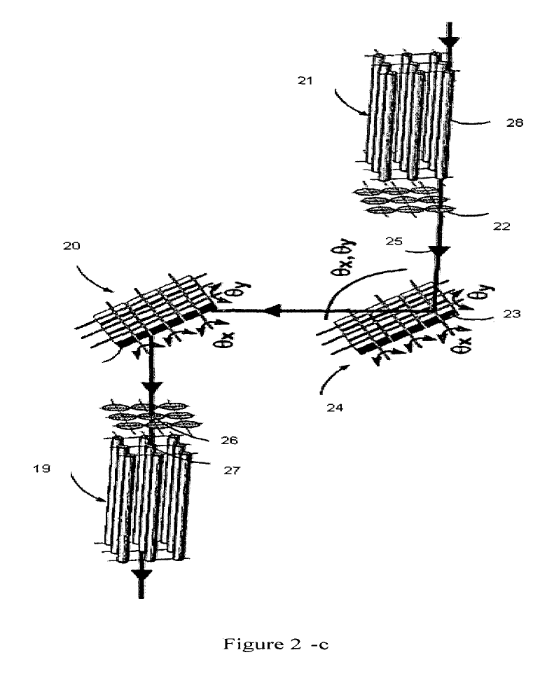

FIG. 1 shows a two dimensional array of micro-mirrors fabricated on silicon. 2 is the reflective surface and 1 and 3 are the supports. The orientation of these mirrors is changed by electromagnetic means. The details are given in the later part. The radius of the micromirror is around 50 to 100 micrometers. Their spatial shift in space is about 50 micrometers.

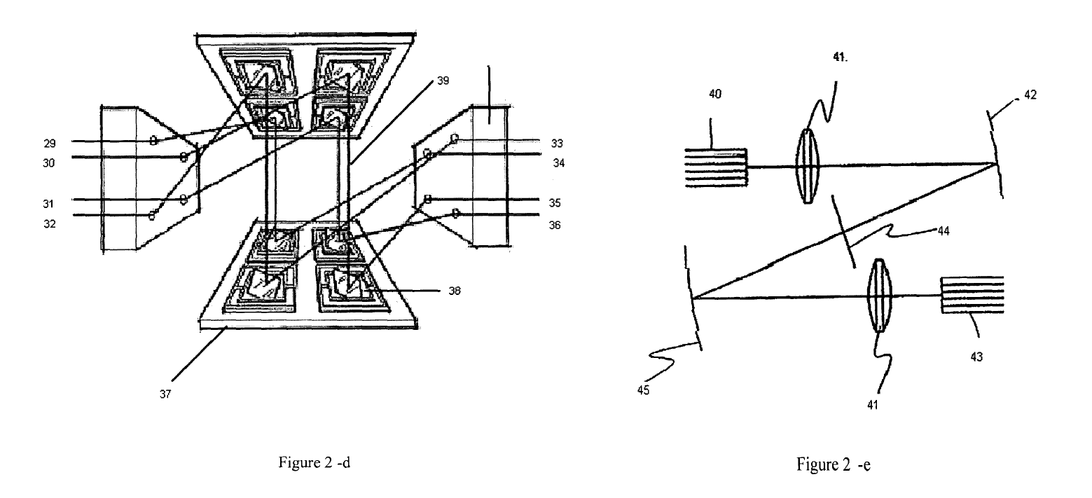

FIG. 2-a shows bundles of optical fibres. 5, 6, 9 and 10 are fibres, 4 and 8 are reflective blocks, 7 is one of the many mirrors in the two dimensional array. By varying the spatial orientation of the mirrors, we can change the path of the signal.

FIG. 2-b has lenses 19 besides the components of FIG. 2-a. When light comes out of an optical fibre in free space, it diverges, so we use lenses to converge the light at a point. The mirrors 17 are placed at the point of convergence. Light falls at a certain angle and is reflected at the same angle by the mirrors to the lenses at the front of optical fibres and subsequently it passes to the corresponding fibres. Other figures viz. 2-C, 2-D, 2-E show the same effect. The figures describe the background art in some detail and the purpose of the present invention is to present novel ways to solve the problem highlighted in these figures.

### EMBODIMENT 1

Deep X-ray lithography is usually combined with electroplating to form high aspect ratio micro-mechanical structures. In LIGA process, photoresists are exposed with X-rays passed through a suitable mask and developed. This is followed by electroplating and this results in metal structures with very high aspect ratios.

Magnetic circuits can be easily fabricated on silicon by using lithographic techniques. Such a device has been discussed in the U.S. patent application entitled “Single coil bistable, bidirectional micromechanical actuator” (U.S. Pat. No. 5,808,384)

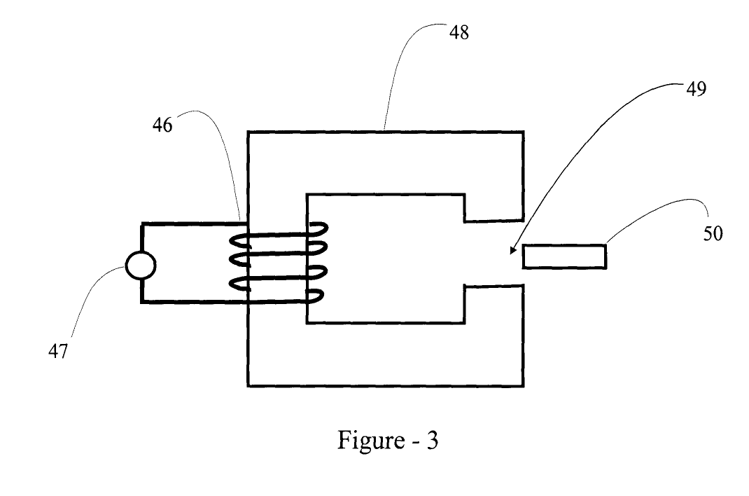

FIG. 3 shows a magnetic circuit 48 composed of ferromagnetic materials built on a non magnetic substrate fabricated using the above process. A copper coil 46 is wound around one block of the ferromagnetic material. In the other part we have a gap 49 in which the magnetic energy of the circuit is stored. A plunger 50 is kept close to it on a frictionless support (not shown in the diagram) whose orientation is along the x-axis. When the voltage source 47 is switched on, a current flows and the magnetic flux lines are set up in the ferromagnetic material. The magnetomotive force is given by
F=NI (1)
where N is the number of turns in the wire and I is the current in the coil. The magnetic flux set up in the circuit is given by

$$ϕ = \frac{F}{R} \qquad ( 2 )$$

R is the reluctance of the magnetic circuit. The following equation correlates magnetic flux density and the total flux

$$B = \frac{ϕ}{A} \qquad ( 3 )$$

A is the cross sectional area of the air gap. The reluctance of the air gap is determined by the following equation

$$R = \frac{l}{μ A} \qquad ( 4 )$$

l is the the length of the air gap, μ is permeability of the medium and the inductance is given by

$$L = \frac{{N}^{2}}{R} = \frac{{N}^{2} μ A}{l} \qquad ( 5 )$$

The total energy of the field in the air gap

$${W}_{fld} = \frac{1}{2} \frac{{N}^{2} {μ}_{0} ld ( 1 - x / d )}{2 g} {i}^{2} \qquad ( 6 )$$

2g is the total air gap length, l is the thickness of the core and d is its width. The total force acting on the plunger is given by

$$F = \frac{ⅆ {W}_{fld}}{ⅆ x} = - \frac{1}{2} \frac{{N}^{2} {μ}_{0} l}{2 g} {i}^{2} \qquad ( 7 )$$

The negative sign indicates that the force is attractive in nature.

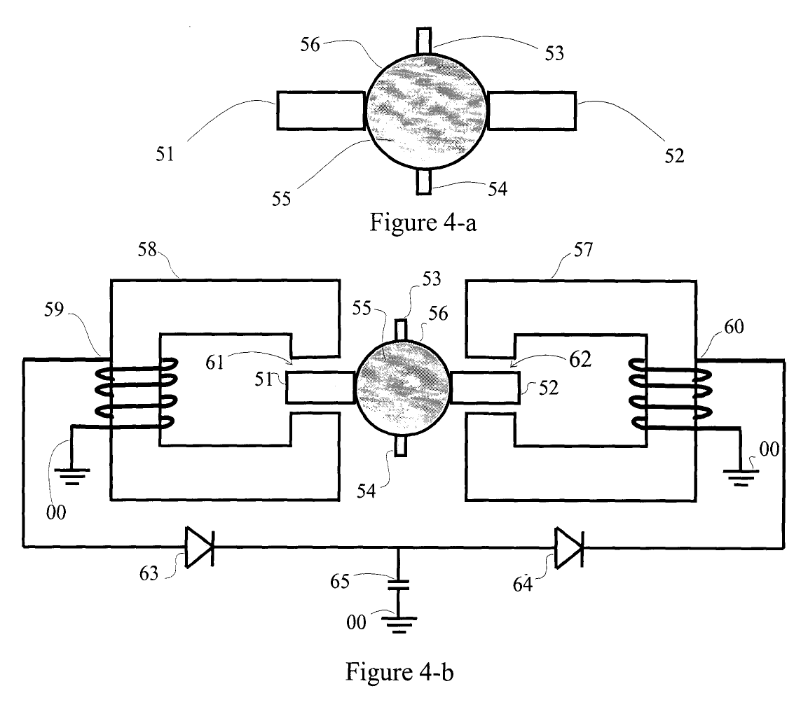

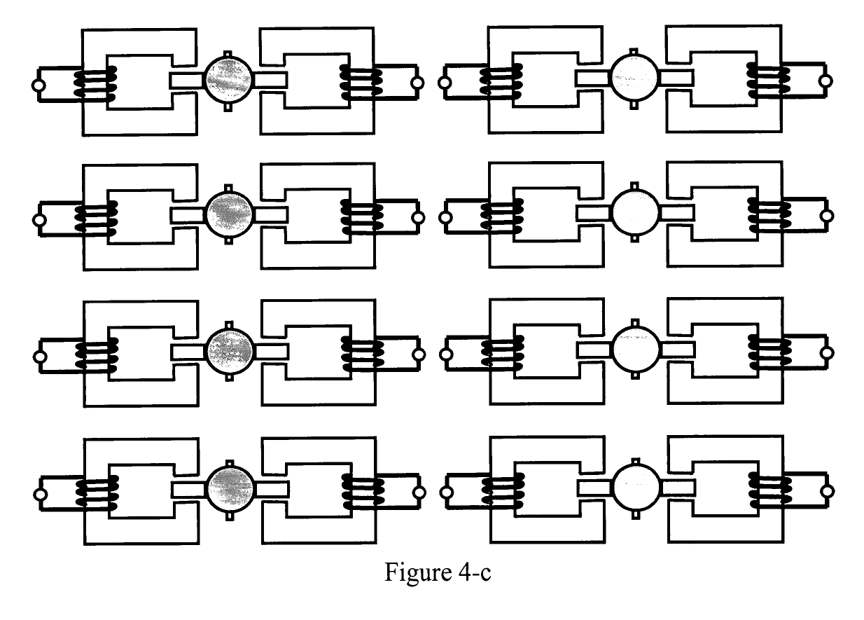

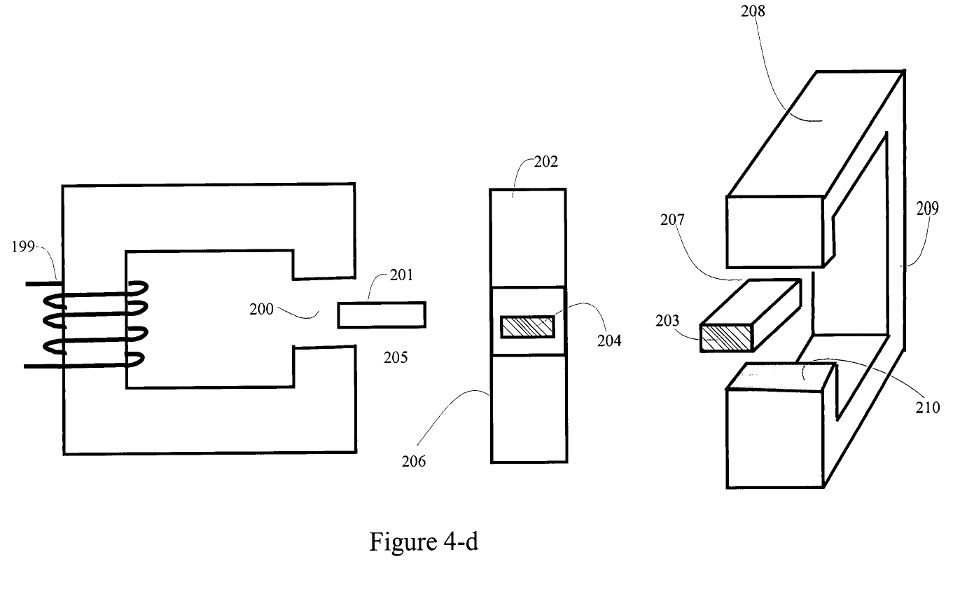

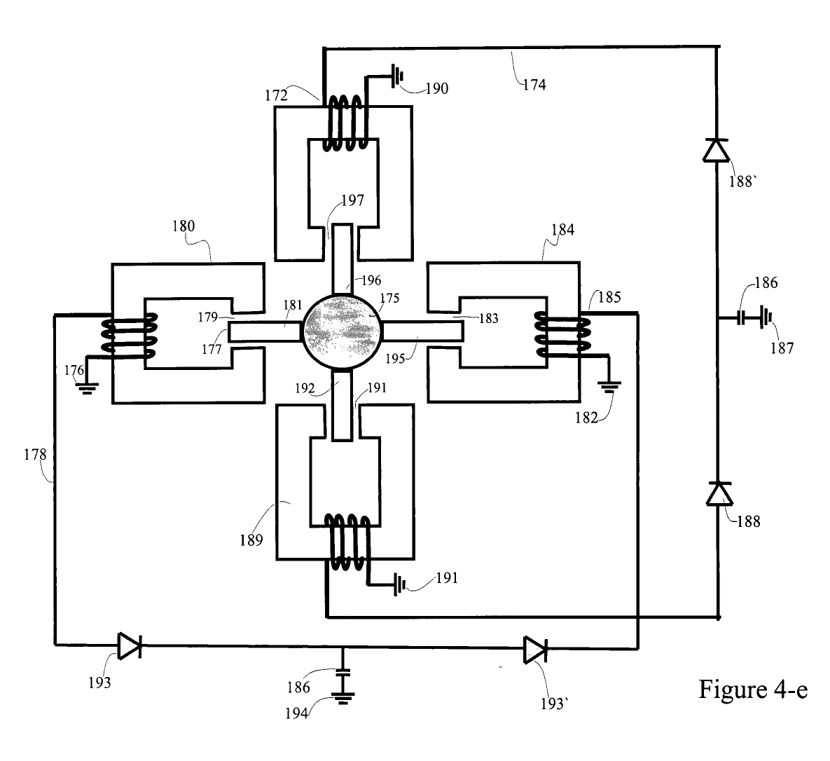

FIG. 4-a shows a mirror having a reflective surface 55 which is a thin coating of aluminium or gold or silver. 51 and 52 are two plungers connected to it at the ends. These can be made of some ferromagnetic material like iron or alnico. They can also be permanent magnets. 53 and 54 are the ends of the hinged support of the mirror about which the mirror can rotate.

FIG. 4-b shows the mirror placed above and between the magnetic circuits 58 and 57 with two plungers 51 and 52 linked to the mirror 56. On an xyz plane, if the mirror is oriented along x direction, then the magnetic circuits are oriented along the z-axis. FIG. 4-d shows its 3 dimensional view.

The capacitor 65 of FIG. 4-b is charged by an external control circuitry (not shown in the diagram) and depending on its polarity, either of the two diodes 63 or 64 get switched on and current flows in one of the coils 59 or 60 and the plunger fixed to the mirror is attracted by the air gaps 61 or 62. A support (not detailed in the diagram) is provided in the air gap so that the mirror reaches a stable position. As per the current in the two circuits, the mirror is in one of its configurations. The reflecting surface 55 transfers the optical signal to the appropriate optical fibre.

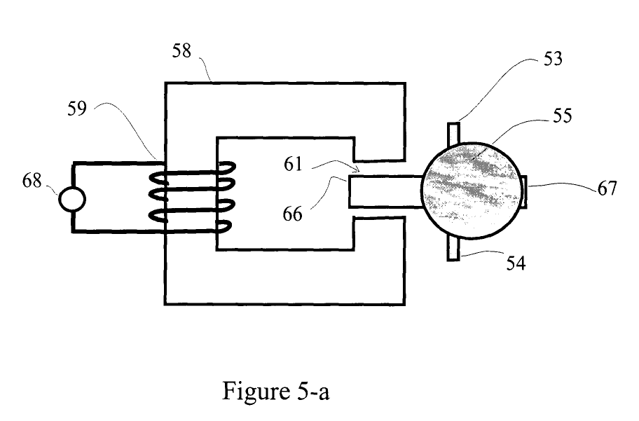

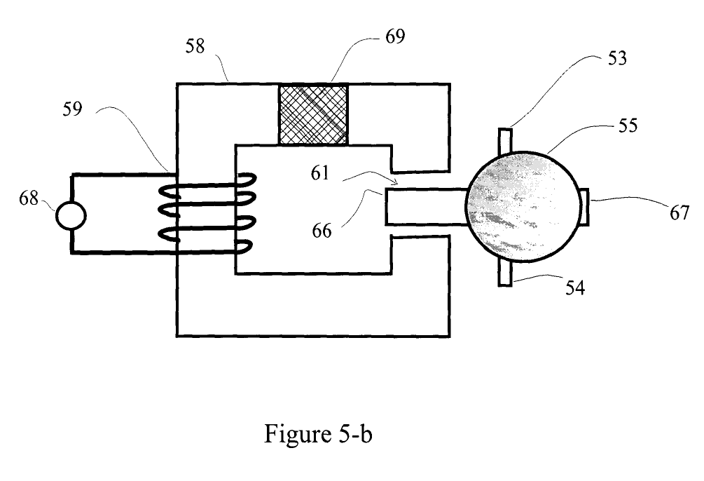

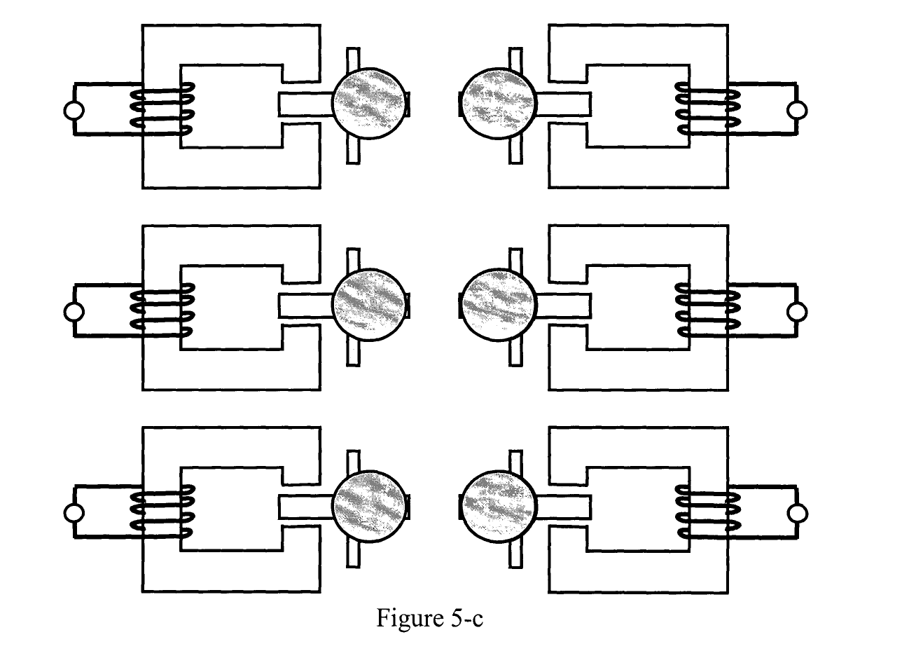

In another embodiment of the device as shown in FIG. 5-a, the mirror is in a mechanically stable position because of the mass 67 attached to the end and when the current is set up in the coil 59, the flux in the air gap 61 attracts the plunger 66 and the mirror deflects in space . The movement is as shown in FIG. 4-d and the mirror is attached to the point 203. In the normal position, the coil 59 has no current and the mirror is in a stable position resting on the hinged support 53-54.

In FIG. 5-b we have a magnetic material 69 in the core 58. The other parts are as in FIG. 5-a. The presence of a magnetic material strengthens the flux density and the net requirement of current in the coil 59 is low. FIG. 5-c shows its two dimensional representation.

The greatest advantage associated with the methods outlined is better control mechanism. Feedback control systems can be easily coupled to such a system for error reduction. Electromagnetic control can also permit direct control of the mirrors using digital signal processors, ASIC for example.

The vibrations associated are low and there is no problem of discharge (which occurs in electrostatic control).

### EMBODIMENT 2

Sliding Mirrors:

Switching can also be done simply by shifting the mirrors rather than by tilting them. This is a big problem as there are limitations related to the movement of the mirrors. In another embodiment of the device, sliding mirrors have been shown to achieve switching.

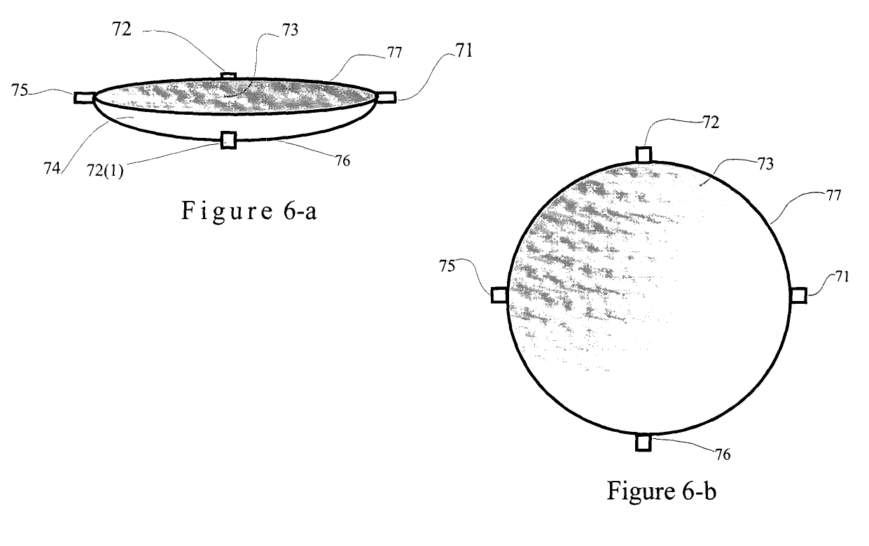

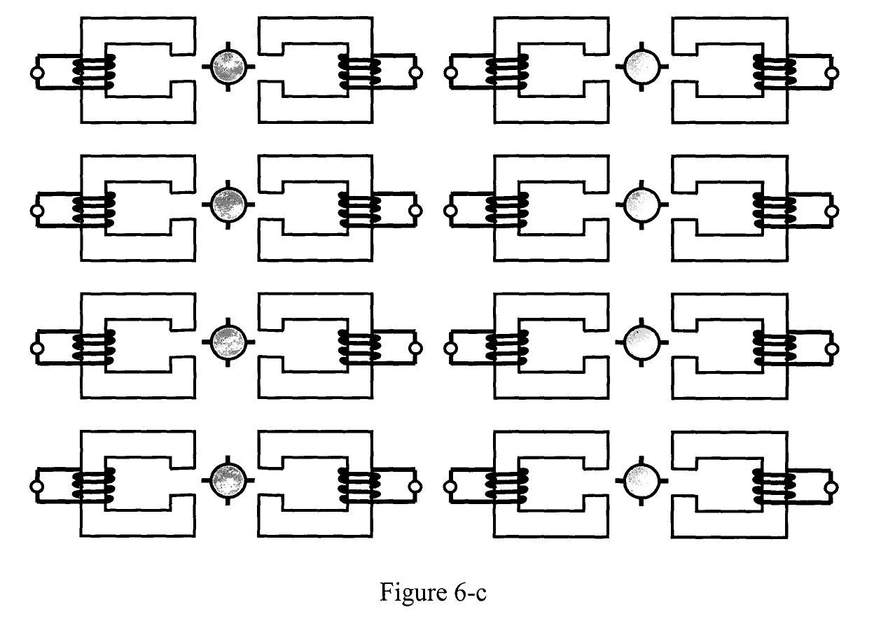

The base 76 of the mirror 77 shown in FIG. 6-a is shown to be flat so that it can slide but the ends 74 are curved. The base of the mirror has a coating of some ferromagnetic material. Plungers 71, 75, 72, 72(1) made of permanent magnetic material are connected to the ends of the mirror. The magnetic circuits are covered with a frictionless sheet (not shown) of a material of high magnetic permeability.

FIG. 6-c shows the two-dimensional lay out. The air gaps of the magnetic circuit has a block (not detailed in the diagram) to accommodate the mirror. The mirror can be moved between these blocks by switching on the corresponding magnetic circuits. In the 3×4 matrix of the magnetic circuit of FIG. 6-c, a mirror is to be moved from the matrix position 11 to the matrix position 34, we switch on and off the circuits 21, 31, 32 and 34. The mirror moves on a very thin layer that covers the magnetic circuits. The mirror is always in a stable equilibrium, hence problems related to vibrations are nil. Proper positioning of the mirror can be a problem. Another problem is the time for the displacement of the mirror. So this embodiment can be used only for small matrices. But we can augment the efficiency by increasing the number of mirrors. Instead of circular flat mirrors, glass slabs with a mirror fixed at its ends can also be used . The sides of the glass slab shall reflect light. This mechanism can also be used to control the motion of the micro-prisms and lenses in optical networks.

### EMBODIMENT 3

Liquid Crystal Based Optical Switches:

Liquid crystals are at the borderline between solids and liquids.—the molecules in liquid crystal do not exhibit any positional order, but they do possess a certain degree of orientational order. The molecules do not all point in the same direction all the time but they have an orientational tendency towards a certain direction called the director of the liquid crystal.

Many liquid crystals viz the tilted smectics show ferroelectricity if they are composed of chiral molecules. In ferroelectric materials the specimen has a number of domains which are themselves spontaneously polarized. When an external electric field is applied, the domain for which the polarization points along the direction of the applied field grows and the other domains are reduced. Finally all the material has a single domain. The domains with a polarization parallel to the applied field grow in the form of thin needles of approximately 1-micrometer width. Due to these reasons, Chiral ferroelectric liquid crystals exhibit a linear electromechanical effect similar to piezoelectricity. As a consequence the electro-optical switching is accompanied with mechanical change in the shape or a converse effect flow may induce polarization. The shape changes are either due to the coupling between director reorientation (Goldstone mode) and flow or to the field induced variation of the tilt angle (electroclinic effect). The influence of an external electric field on the director the liquid crystals have been explained in the reference “Self, Please, Sluckin: Deformnation of Nematic liquid crystals in an applied electric field, Euro Journal of Applied Mathematics, 13, pp 1-23 (2002)”.

As discussed above, the fluid atomic arrangement can be changed under the influence of an external electric field. For our invention, chiral ferroelectric liquid crystals are of interest. So far liquid crystals have been used for switching, but this has been based on the concept that liquid crystals show different refractive indices for different polarizations.

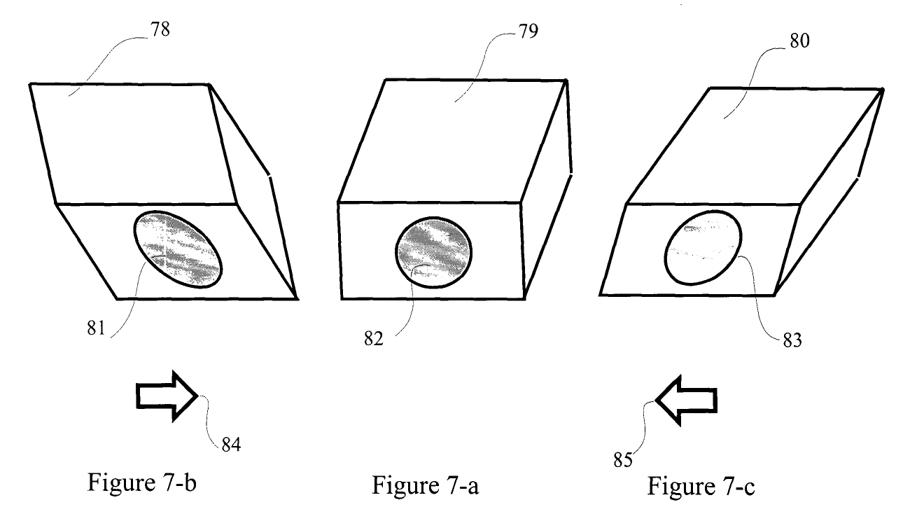

This embodiment of the device combines the advantages of micro-mirrors as well as that of the liquid crystals. Using standard lithographic techniques, a micro-mirror fabricated on silicon can be mounted on a slab of liquid crystal packed on a substrate. This has been shown in FIG. 7-a, where we have a micro-mirror 82 on a slab of liquid crystal 79 . A Variable electric field 84 is applied using electrodes fabricated on the substrate (not shown in the embodiment) such that the shape changes to that of FIG. 7-b. FIG. 7-c indicates the deformation due to the field 85. These are the two orientations of the mirror.

The advantages are fast switching times and absence of mechanical vibrations. The same mechanism can be used to control the motion of prisms, lenses and similar devices. They need to be attached to a slab of liquid crystal using photolithography and standard micromachining techniques.

The angular shift of the reflected ray from a mirror is twice that of its mechanical tilt. To amplify the angular shift the reflected ray, additional mirrors could be used.

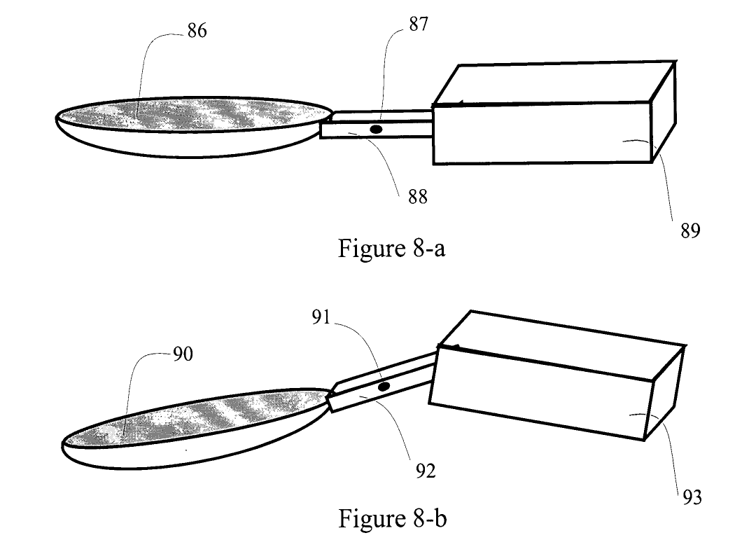

A slight variant of the device has been shown in FIG. 8-a. A lever 88 hinged at 87 has been attached between the slab of liquid crystal 89 and the micro-mirror 86. When the variable electric field is applied along the upward direction using an electrode (not shown in the embodiment) the lever's position is changed as indicated in FIG. 8-b. As the lever is hinged close to the liquid crystal, its movement is amplified and so the micro-mirror shows a large orientational shift. When the electric field is removed, initial condition is achieved. The major advantages of the lever arm is that control can be done even for a small deformation in the crystal shape which needs small value of electric field.

A two dimensional array of the above embodiment can be used to do switching between N×N fibres.

### EMBODIMENT 4

The electro-optic effect is a second order nonlinear optical process in which the refractive index of a material changes due to an applied static electric field. The change in the refractive index along the i-axis, nᵢ is related to the static electric field applied along the j axis, Eⱼ, according to the following equation

$$Δ n = \frac{{n}^{3}}{2} {r}_{ij} {E}_{j} \qquad ( 8 )$$

where n is the refractive index of the material before the electric field is applied. r, the electrooptic coefficient, is a second rank tensor whose i and j components are rᵢⱼ. If the electric field is in some arbitrary direction, the index j is summed over its Cartesian components.

If a linearly polarized light passes through an Electro-optic crystal, the phase retardation (Γ) will be induced by Δn which is given by
Γ=2πΔnL (9)
where L is crystal length, putting in the value of Δn, we get

$$Γ = π L {n}^{3} {r}_{ij} \frac{{E}_{j}}{λ} \qquad ( 10 )$$

It is clear that the phase of light will change together with electric field (E). This is called electro-optic phase modulation.

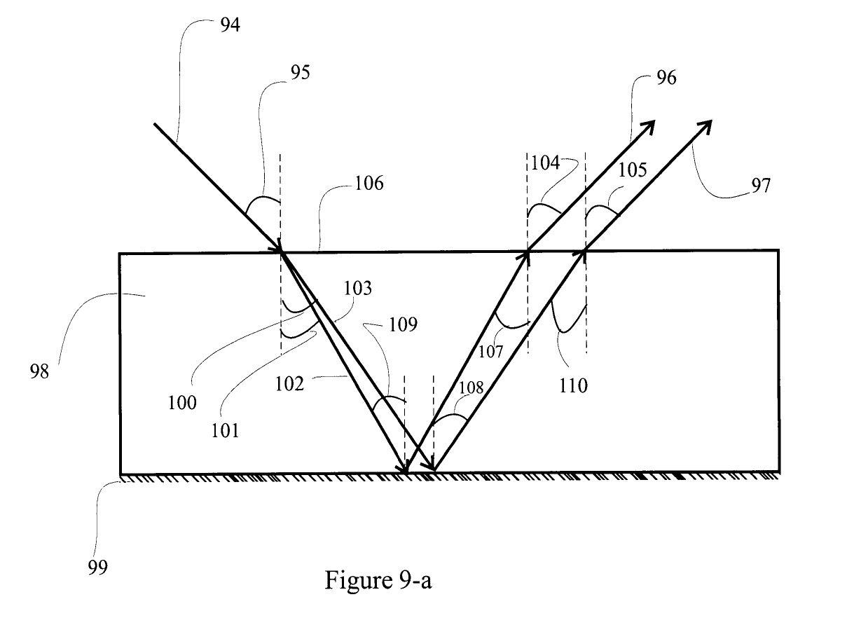

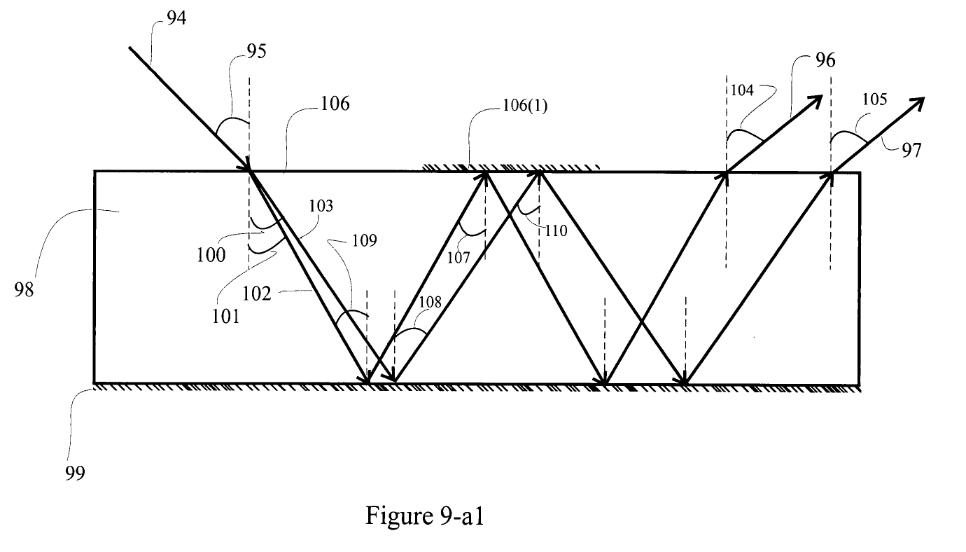

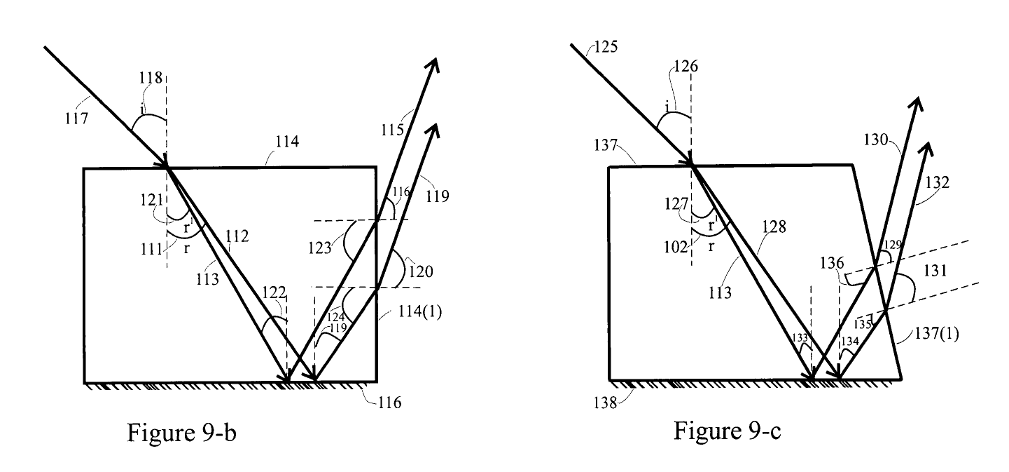

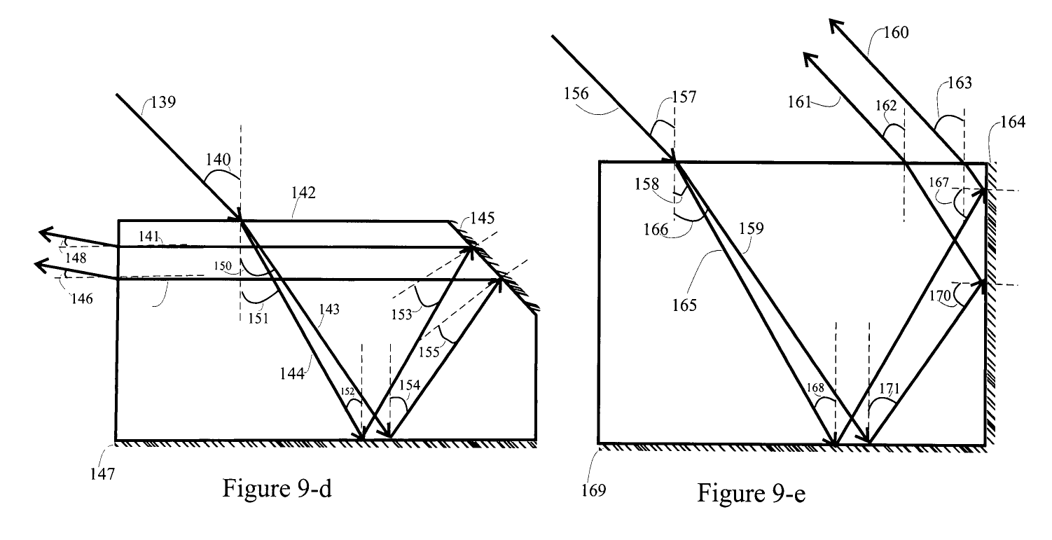

In this embodiment as shown in FIG. 9-a, a slab of an electro-optical material is used. It has a certain thickness t and 2 refractive indices n1 and n2 for different values of electric fields. The upper surface 106 is transparent and the lower surface 99 is polished. A ray of light 94 incident at an angle 95 falls on the side 106 of slab 98. 102 and 103 are the refracting rays for refractive indices n1 and n2. The angles of refractions are 101 for the ray 102 and 100 for the ray 103. When they reach the reflective layer 99, they are reflected at angles 109 and 108 and are incident on the layer 106 at angles 107 and 110 respectively. The final rays that come out are 104 and 97.

In FIG. 9-a, for the ray 102 which is the refracted ray for refractive index n1, the following angles are equal
∠101=∠109=∠107 (11)
These are alternate angles. hence,
∠95=∠104 (12)

These are the angles of incidence and the final angle of refraction. This is clear from snell's law which says that the product of refractive index and the sine of the incident angle is equal to other refractive indices and incident angles when a ray of light passes through various mediums. Similarly for the ray 103 which is the refracted ray for the index of refraction n2,
∠100=∠108=∠110 (13)
hence,
∠95=∠105 (14)
Thus the final angles of refractions for the two rays are equal i.e.
∠104=∠105 (15)
This implies that the emergent rays are parallel to each other.

If the thickness of the glass slab is t and the distance between the point of incidence and point of refraction is x1, for the ray 102,
X1=2t(tan 109)=2t(tan 101) (16)
Similarly the net displacement for the ray 103
X2=2t(tan 108)=2t(tan 100) (17)
The net distance between the fibres between which switching has to be done
D=X2−X1=2t[(tan 100)−(tan 101)] (18)
As indicated in the figure ∠100 and ∠101 are the angles of refraction for two values of refractive indices. Thus the spatial variation of the ray introduced by bringing a change in the refractive index is useful in switching between the optical fibres.

To augment the spatial displacement of the final refracted rays (96 and 97 in this case), we can also use faceting of the side 99 at certain angles. Thus the angle of incidence would be different for different rays and the net spatial displacement can be increased.

In FIG. 9-a1, the portion 106(1) of the face 106 has been polished and so the light is reflected again from this point and when the rays 96 and 97 finally emerge, their mutual distance is large. In this case each ray has been reflected twice and the net spatial displacement of the emergent rays is
D=4t[(tan 100)−(tan 101)] (19)

By having n reflections in the slab before the rays emerge, the net displacement between the fibers is
D=2nt[(tan 100)−(tan 101)] (20)
To augment the distance between the emergent rays, we can use this method successively. We can also allow the ray 102 to pass from the side 106 simply after the first reflection and this shall further increase the distance between the emergent rays.

In FIG. 9-b, the rays 115 and 119 come out from the side 114(1) and using the analysis of the earlier section, we can prove that the final rays are parallel to each other. FIG. 9-c shows cleaving of one of the sides 137(1), the basic advantage of the configurations 9-b and 9-c is that a change in the direction of the optical signal is brought by modulating the slab shape.

In FIG. 9-d, the faceted side 145 is polished to reflect light and this is instrumental in changing the direction of light completely. FIG. 9-e has the sides 169 and 164 polished and this reflects light by 180 degree while creating displacement in the poynting vector. Using snell's law, we can prove that the emergent rays are parallel in all the cases. Similar other configurations can be developed to suit our needs. Similarly, we can use various layers of successively increasing refractive indices to bring about better switching. In yet another model, the refracted light is allowed to follow a longer distance to create displacement of the wavefront. Increasing the slab thickness can do this.

The above description is suitable for switching 1 input signal to a number of output ports. For MXN switching system we shall need M slabs which shall require N voltage levels to switch to N output ports for N various refractive indices. All the slabs shall need electrodes to apply varying level of electric fields. These can be developed using standard micromachining techniques on silicon and thus an integrated system on chip can be developed.

1. One or more coils wound round a ferromagnetic material that forms a magnetic circuit. The entire structure developed on a semiconductor substrate using standard fabrication methods.

2. An integrated source of direct current for the coil of claim 1.

3. Air gap in the magnetic circuit of claim 1.

4. A plunger fabricated using the process of claim 1 that can move in and out of the air gap of claim 3 on a frictionless surface.

5. A mechanical mechanism to stop the motion of the plunger of claim 4.

6. A micro-mirror pivoted on a hinge about an axis fabricated through micromachining on silicon and joined to the plunger of claim 4.

7. Another plunger linked to the micro-mirror of claim 6.

8. Tilting of the micro-mirror of claim 6 by attraction of the plunger in the air gap of the magnetic circuit of claim 1 when current flows through the coil to create a change in the path of optical signal.

9. Use of the micro-mirror of claim 6 along a two dimensional array for an N×N, M×N or NXM optical cross connect.

10. A mass attached to the micro-mirror of claim 6 so that the mirror is in one stable position by the gravitational attraction of the mass.

11. Tilt of the micro-mirror with the mass attached of claim 10 with the excitation of the coil of claim 1 and switching action.

12. A two dimensional representation of the structure of claim 11 for an N×N, M×N or N×M optical cross connect.

13. Use of a permanent magnetic material in the magnetic circuit of claim 1 to augment the flux density in the air gap of claim 3.

14. A micro-mirror with a flat base and convex edges free to slide on a two dimensional surface.

15. N or M plungers linked to the micro-mirrors at a fixed angle to each other.

16. A sliding mechanism for the micro-mirror of claim 14 on the magnetic circuit of claim 1.

17. N×N, M×N or N×M magnetic circuits of claim 1 and displacement of mirrors about the air gap of magnetic circuits and switching of the optical signals through spatial displacement.

18. An optical element (a lens, a micro-mirror, a prism) mounted on a slab of liquid crystal on a semiconductor substrate using standard fabrication techniques.

19. Electrodes as sources of electric field to deform the liquid crystal integrated with the slab of liquid crystal and the optical element of claim 18.

20. Orientation change in the optical element of claim 18 arising out of this deformation and switching of the optical signal between a plurality of input and a plurality of output fibres.

21. A lever connecting the optical element of claim 18 to the liquid crystal to amplify the motion of the optical element with crystal deformation.

22. The lever hinged to a point close to the liquid crystal.

23. A two dimensional representation of the arrangement of claim 18 for optical switching.

24. A thin slab of an electro-optic material like lithium niobate whose refractive index changes under an external electric field.

25. Polishing of one end of the slab of claim 24 and leaving the other end of the slab transparent so that refraction and reflection are possible.

26. An electrode as a source of electric field which changes the refractive index of the material and creates a change in the angle of refraction of the incident radiation. This ray when reflected from the other end is displaced in space from the reflected ray for a different refractive index.

27. Faceting the edges of the slab of claim 21 to manipulate the directional orientation of the reflected ray.

28. Polishing the faceted edges of the slab of claim 21 to create changes in the incident radiation within or beyond the slab.

29. Polishing other sides of the slab of claim 21 in discrete or continuous manner to manipulate the direction of light within or outside the slab.

30. Faceting the lower (reflective) end of the slab of claim 21 to manipulate the direction of reflected light within the slab.

31. Use of the device of claim 26 in a two dimensional array for switching of signals in an N×N, M×N or N×M system.
